(19) United States
(12) Patent Application Publication
(10) Pub. No.: US 2004/0215484 A1
(43) Pub. Date: Oct. 28, 2004

(54) Warranty extension through additional sales and warranty reminders in download

(75) Inventors: Russell F. McKnight, Sioux City, IA (US); Glen J. Anderson, Sioux city, IA (US)

Correspondence Address: GATEWAY, INC., ATTN: SCOTT CHARLES RICHARDSON, 610 GATEWAY DRIVE, MAIL DROP Y-04, NORTH SIOUX CITY, SD, 57049, US

(73) Assignee: Gateway, Inc.

(21) Appl. No.: 10/852,020

(22) Filed: May 24, 2004

Related U.S. Application Data
(63) Continuation-in-part of application No. 10/353,697, filed on Jan. 29, 2003.

(51) Int. Cl. G06F 17/60

(52) U.S. Cl. 705/1

(57) ABSTRACT

A method for extending the warranty on a first good by purchasing additional, related goods, involves a determination of the cost per unit time of the warranty extension for the first good based on information received about such first good. Information about at least one good which is related to the first good is received, and in a dollar amount corresponding to such related good is determined based on such information. The method can be incorporated into a computer-implemented system or a software program, and is particularly suitable for use when the goods are computer systems, and the additional goods relate to such computer systems. Still another purchased goods about extended warranty offers. Such a warranty reminder is presented to a customer without the customer having to actively seek out information that would otherwise trigger a warranty offer.

### CROSS-REFERENCE TO RELATED APPLICATIONS

This application is a continuation-in-part of co-pending U.S. patent application Ser. No. 10/343,697, filed Jan. 29, 2003.

### FIELD OF THE INVENTION

This invention relates to a business method for selling manufactured goods having warranties and, more particularly, to methods associated with selling computer hardware, software, and related goods, and reminding customers of extended warranty offers.

### BACKGROUND OF THE INVENTION

When a customer purchases a manufactured good, such as a computer or computer system, the manufacturer or seller of the good generally includes or offers a warranty having a certain duration and a certain scope. Under the warranty, the manufacturer or seller typically undertakes to preserve or maintain the utility or performance of the manufactured good, provide compensation or arrange for repairs to the good if it fails to function properly, or protect the consumer from having to replace the good if the good gets damaged in some way—all subject to various limitations, terms, and conditions of the warranty. In the case of computer systems, most systems come with a limited warranty that gives the customer free technical support and part replacement for a limited period of time—subject to various limitations, terms, and conditions of the warranty. Computer systems sometimes include service or maintenance agreements in their associated warranties, or various other assurances against malfunction or breakdown. Warranties thus are many and varied.

Warranties for manufactured goods are often provided at the time of sale. As such, the customer may treat the warranty as an inducement to purchase the good. Even so, some customers desire to obtain additional, supplemental, extended, or alternative warranties as further protection against risk of loss or other malfunction of the good. To address this demand, retailers, credit card companies, and other entities, under certain circumstances, have been willing to provide further warranties to those available from the manufacturer, usually for an additional fee. These additional or extended warranties thus have a value of their own and, as such, constitute a marketable product in their own right.

In the context of the computer industry, if the customer desires to extend the warranty on a computer system, the customer generally has more than one option from more than one warranty provider, including the manufacturer/seller or third-party providers. As such, it is sometimes a challenge for the original manufacturer/seller to differentiate its warranty offer from those of third parties, unless the manufacturer/seller can convince the customer that such warranty is associated with a better price or better terms and conditions than those of other extended warranty providers. In view of this, when the consumer is deciding from whom to purchase an extended warranty, manufacturers or sellers often cannot rely on the fact they manufactured the article or previously provided its warranty to make up for more expensive warranty or service plans.

Computers are often components of larger computer systems. The components of such systems are not always purchased at the same time, and not always from the same manufacturer or seller. The system is often expanded by the purchase of additional components or upgraded by the replacement of older components with newer ones.

A computer system generally includes not only a server, personal computer, or other CPU hardware, but also peripheral hardware devices, such as printers, scanners, docking stations, and input devices; networking devices; and various other related hardware components, along with supplies and parts for the foregoing. Further components of computer systems also include any number of software applications for which the computer is to be used, as well as operating systems software, drivers, connectivity services, and any other programming for the various components of the computer system to function properly and communicate as required.

A computer system thus has many components, both hardware and software and associated services, parts and supplies, which can be termed “related products.” Otherwise stated, related products encompass any hardware, software, networking or communication services, or supplies which a customer may use in association with the CPU of the computer, such as computer peripherals, software applications, the computers themselves, new models to replace existing computer hardware, and all of the various parts and components associated with computer systems.

There are many sellers and manufacturers of such related goods and, accordingly, the customer generally has few incentives to return to the same seller or manufacturer to purchase goods related to the computer system originally purchased. Incentives are generally limited to coupons, advertisements, and other traditional marketing techniques of retailers in the computer industry. There is thus sometimes a lack of “brand loyalty” in decisions to purchase products or goods related to the computer or computer system originally purchased.

Accordingly, there is a need for overcoming the disadvantages and drawbacks of the current art with respect to warranty extensions and the purchase of additional goods related to an originally purchased good.

### SUMMARY OF THE INVENTION

In accordance with one aspect of the invention, a method determines a warranty extension for a good purchased by a customer. The method includes or involves receiving information about the good which has been purchased. Based on this information about the purchased good, a cost per unit time for a warranty extension is determined. Information about goods which are related to the purchased good is also used in this method, this information including a dollar amount which corresponds to the related product. The method multiplies the cost of the warranty extension per unit time and the dollar amount for the related product to determine a corresponding amount of time for the warranty extension.

In accordance with another aspect of the invention, the above-described method is implemented through a software program which includes suitable programming for accomplishing the actions and steps mentioned above.

In accordance with still another aspect of the invention, a method or process generates a warranty extension offer for a customer's computer system. This method or process involves information about the customer's computer system. Here, this information is used to compute the cost for a predetermined unit of time for the warranty extension and this information is likewise used to determine products which are related to the customer's computer system. For each of these related products, a corresponding dollar amount is determined, and this dollar amount generally corresponds to a predetermined percentage of the cost or price of said related product. The dollar amounts of at least some of the related products are added up until a corresponding total dollar amount is obtained. The method compares the total dollar amount to the cost for the predetermined unit of time for the warranty extension calculated previously. When the dollar amounts of a sufficient number of related products have been added up so that their total is greater than or equal to the cost for predetermined unit of time of the warranty extension, then the corresponding related products, once purchased, will extend the warranty of the customer's computer system by an amount corresponding to the total dollar amount of the related products purchased. The amount of the extension is greater than or equal to the predetermined unit of time for the warranty extension.

Still another aspect of the present invention is to provide a computer-implemented system which generates a warranty extension offer in accordance with the above-described method or process.

Further aspects of the present invention involve a method for applying the unused warranty on a purchased good to a good related to the purchased good. In this aspect, input is received which identifies or corresponds with the purchased good and which also corresponds to the amount of the unused warranty on the purchased good. The value of the unused warranty is calculated as a function of this input. Information is received which includes pricing of at least one good related to the purchased good, as well as the costs of warranty of such related good or goods. The method uses the value of the unused warranty on the purchased good and at least some of the information for the related good to perform one or both of the following actions: (1) reducing the price of the related good by an amount which corresponds to the value of the unused warranty; and/or (2) establishing a warranty for the related good for an initial or an extended period of time as a function of the cost of the warranty of the related good and the value of the unused warranty on the purchased good. In one version of the above method, the purchased good is a first computer which has unused warranty left and the related good is a newer computer which is either replacing the older computer or being added to the customer's computer system.

Still another aspect of the present invention is to provide reminders to consumers who have purchased goods about extended warranty offers. Such a warranty reminder is presented to a customer without the customer having to actively seek out information that would otherwise trigger a warranty offer.

The warranty reminder may be initiated after a predetermined time, such as, but not limited to, a set number of days after the customer initially activates the computer or computer system, a set number of days after a customer initially purchases a computer or computer system, after a set number of reboots of the computer, on a predetermined date, or any combination thereof. In accordance with one embodiment of the invention, the warranty reminder relates to warranty information of the computer or computer system, wherein a computer program application on the system, on the web, or otherwise readily accessible, tracks the warranty information in order to provide a warranty reminder.

### BRIEF DESCRIPTION OF THE DRAWINGS

The invention will be better understood by reference to the drawing, which schematically illustrates certain embodiments of the invention, with reference to the following figures:

FIG. 1 is flow chart schematically illustrating one general embodiment of the invention;

FIG. 2 is an additional flow chart illustrating certain steps and systems of FIG. 1 schematically in more detail;

FIG. 3 is a flow chart illustrating another embodiment of the invention particularly useful for a customer's computer system;

FIG. 4 is a schematic showing another, alternative embodiment of the present invention; and

FIG. 5 is a diagrammatic view of one of the many computer systems suitable for use with, incorporating or practicing the steps of any of the embodiments of the present invention.

FIG. 6 is a flow chart illustrating another general embodiment of the present invention with respect to warranty reminders.

FIG. 7 is a flow chart illustrating a general embodiment of the present invention with respect to tracking warranty information through a software program.

### DESCRIPTION OF PREFERRED EMBODIMENTS

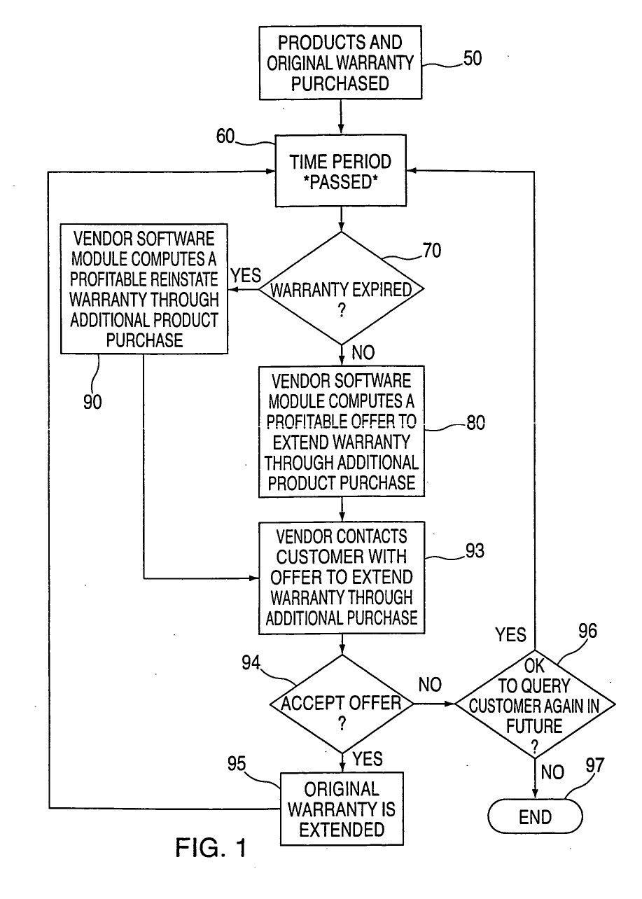

Referring now to the drawings, and in particular to FIG. 1, a method or process 50, according to one preferred embodiment of the present invention, is diagrammed schematically and generally shows how a warranty extension offer for a good purchased by a customer is generated. The steps of the method or process 50 involve a purchase of a manufactured good and an original warranty associated with such purchased good. Once the good and associated warranty have been purchased, the process 50 seeks to “leverage” such original purchase by offering to extend the warranty on the purchased good through purchase of related goods from the seller. In addition to its usual meanings, the terms “purchase,” “purchased,” or its variants, when used herein, shall encompass any of the various ways a customer comes into possession of or acquires the good or product, including, without limitation, outright purchase or installment purchase, credit, lease, gift, transfer or other type of acquisition.

Thus, a customer desiring either an extended warranty for the original purchases or additional goods related to the customer's original purchase would be interested in the seller's offer because it accomplishes both goals. The seller, for its part, increases revenue if the offer of extended warranty induces the customer to purchase related goods from the seller, rather than from a competitor.

As such, the seller may approach the customer at the time of the customer's purchase of the original good and warranty or, as shown in step 60 of FIG. 1, the seller may optionally let a period of time pass before instituting subsequent steps in the process. In a computer implementation of process 50, the seller can mark certain customers or accounts for follow-up after a desired period of time has passed. Alternately, suitable programming can be implemented which prompts the seller to make an offer to the customer upon the customer's purchasing a certain amount of goods with associated warranties.

The process 50 checks whether the warranty on the original product has expired in logic block 70. If yes, then suitable program routines 90, discussed in more detail subsequently, compute, generate, or determine (such terms being interchangeable as used herein) a warranty extension in the form of a reinstatement of warranty coverage as a function of the purchase of additional related goods or products.

In the event the warranty on the original product has not expired, then step 80 occurs which, similar to step 90, determines an extension of the existing, non-expired warranty as a function of the purchase of additional products related to the original, purchased good. Whether reinstating an expired warranty or extending an existing warranty, the determination of the warranty extension is preferably, though not necessarily, implemented by suitable programming routines on a computer system. After the warranty extension has been determined, it is communicated either electronically, verbally, or by other suitable means to the customer in the form of an offer to extend warranty on the originally purchased goods by purchase of additional goods (step 93). The customer can either accept or reject the offer (step 94).

Upon acceptance of the offer and purchase of the related goods, the original warranty is extended or reinstated for a period of time in step 95. Optionally, a database containing the warranty information is updated to reflect the extension of time.

If the offer is rejected, suitable programming can record whether it is acceptable for the customer to be contacted again in the future about warranty extensions in return for purchases of additional goods (step 96). Whether the offer has been accepted or rejected, additional offers to extend warranty through purchase of related goods can be made, assuming the customer has not objected to such offers. After ending one offer “cycle” (step 97), the method can be repeated.

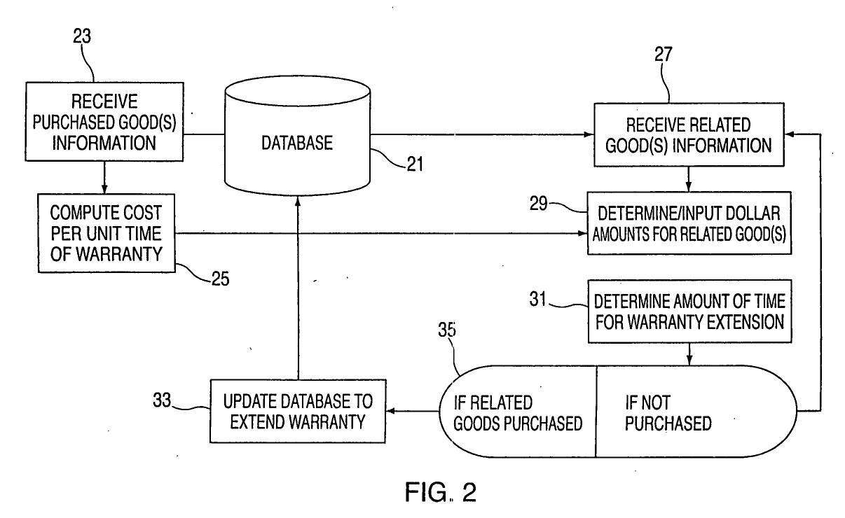

The steps and associated subroutines for implementing the process 50, and in particular steps 70, 80 and 90, are now discussed with reference to FIG. 2, which shows a flowchart for one preferred embodiment of the invention, in the event the invention is implemented using a computer system. Suitable programming is provided for input to be received from database 21, as shown by action block 23, in which the inputs include information related to or associated with the purchased good or goods. The computerized implementation of the method includes suitable programming to perform the actions of block 25, which include computing a cost per unit of time of a warranty extension. This computation can be accomplished using any of a variety of variables and information, depending on the particular application, the particular goods, and the particular related goods to be purchased by the customer.

In the illustrated embodiment, the information for the purchased good preferably includes an identifier for the purchased good, such as a serial number, and then suitable means are provided to associate additional information with the identified purchased good, such additional information including, preferably, the age of the purchased good, the components included within the purchased good, or the cost of in-warranty support of products similar to the purchased good. Some or all of these pieces of information are used as variables in “rules,” which are generally in the form of computational steps. The variables are associated with the appropriate rules or equations, and computations are performed to determine the cost per unit time of warranty extension. Again, the weight ascribed to any of the variables discussed above can be adjusted to suit the particular attributes of the goods which have been purchased, or to accurately reflect the costs associated with extending a warranty for a predetermined or a particular unit of time.

Suitable programming exists to receive as inputs further information from database 21 in action block 27. This further information is associated with goods which are related to the purchased goods, that is, goods which a customer would consider purchasing to use in conjunction with the originally purchased goods. Goods related to the purchased goods are thus preferably determined by access to database 21. However, when the terms “determine,” “determined,” or variants thereof are used herein for related goods or for any other aspects of the invention, these terms, in addition to their usual meanings, include simply identifying the related goods or other items, as well as getting the information by manual input or other suitable methods, without necessarily needing a computer step to make a traditional “determination.”

The information for the related goods preferably includes a dollar amount associated with the related goods determined by any suitable means. The dollar amount can be determined by receiving the dollar amount as an input from database 21, it can be determined by applying rules, variables, or factors to information about the related goods, or the dollar amount can be determined by manually assigning a value to it (action block 29).

The dollar amount, in one preferred embodiment, is not simply assigned, but rather is the result of taking a percentage of the cost or price of the related good. In other embodiments, the resulting dollar amount is expressed in terms of a percentage of the profit margin for the related good. Profit margin in this case corresponds to the percentage amount the vendor makes after taking into account the various costs associated with the goods. An acceptable portion or percentage of this profit margin is thus applied to the warranty extension on the originally purchased good.

Still further, in other alternatives, database structures are formed to include information for each of the related products, such as costs or pricing information, which data can be varied manually or inputted by suitable programming. Again, the resulting dollar amount is preferably achieved either by multiplying the corresponding acceptable percentage by the corresponding price or cost associated with the related goods, by manual input of the vendor, or by database access.

Thus, by way of example, if a related good costs $100 and the vendor has agreed to apply 10% of any purchases or related products toward a warranty extension, then one simple rule could be to multiply the price of $100 by the acceptable margin of 10% which determines a dollar amount of $10. Although this exemplary rule involves only two variables, it may be desirable or appropriate to use different or additional variables or factors in devising appropriate “rules” for determining how much of the price or cost of a related good should be “given back” or credited to an extended warranty. Such additional variables or rules include how long the related product has been on the market, how “hot” the related product is, sales commissions, credits, and incentives applying to the related products or other related products, time of year, etc. As still another possible implementation, more generous dollar amounts are associated with excess inventories of related goods, and such dollar amounts thus correspond to more generous warranty extensions to encourage the sale of the excess inventory. The dollar amounts for the excess inventory may even be set to the point of a profit loss for the sale of the related good.

Whatever rules are applied to determine the dollar amount of the related good or goods, that dollar amount is one of the variables used to determine the amount of time for the warranty extension to be offered. Referring now to action block 31, suitable programming is provided to determine the amount of time of the warranty extension as a function of the dollar amount of the related good(s) and the cost per unit time of warranty extension. Again, in its basic form, the amount of warranty extension is the product of multiplying the cost per unit time of warranty extension determined in action block 25 by the dollar amount determined in action block 29.

Having calculated the amount of warranty extension, an offer to extend the warranty by such amount can be made, which offer includes the related good or goods to be purchased by the customer along with the corresponding warranty extension. In logic block 35 and action block 33, suitable programming responds to whether the related goods which were offered were, in fact, purchased. If yes, then action block 33 updates a suitable portion of database 21 to extend the warranty of the purchased good by an amount corresponding to the warranty extension, thus providing an extended end-of-warranty date for the purchased goods. If no, the process is optionally repeated to generate another offer.

The rules for action blocks 25, 29, and 31 can be tailored to account for any number of circumstances which should be factored into the determination of the warranty extension offer. In addition, the method and corresponding system for extending the offer has the flexibility of accounting for such factors at almost any step in the method or within any subroutine of the corresponding computer implementation. Thus, for example, if it is preferable for the warranty extension offer to consider whether the customer's originally purchased goods were purchased from the vendor offering the warranty extension, a rule or variable reflecting this fact can be included as part of the computation of action block 25, or received as part of the information in action block 23, or factored in at some other point in the process, as appropriate. Likewise, if it is important for the warranty extension to be influenced by the length of time over which the customer has purchased related goods from the vendor offering the warranty extension, then a variable or rule accounting for this fact can be implemented. The variable can be part of the information received for the related goods in action block 27, part of the determination of the dollar amount of action block 29, or, again, at any other suitable location in the method illustrated in FIG. 2.

Similarly, although the foregoing embodiment has been explained with reference to a computer implementation with corresponding programming subroutines for many of the steps of the method, automation is not required for any particular steps. Thus, for example, although inputs are received from database 21 in action blocks 23, 27, they could just as readily be received as manual inputs into a corresponding computer program. Furthermore, the automated computations of action blocks 25, 29, 31, and 33 can be performed manually in whole or in part.

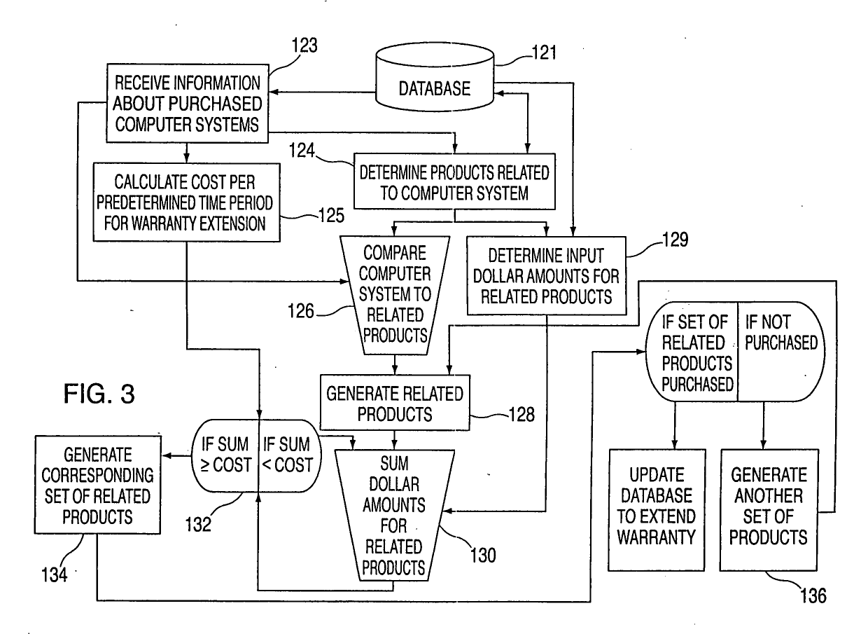

Another preferred embodiment of the invention is shown schematically with reference to FIG. 3 and now described in the context of a customer's purchased computer system. Information about the customer's purchased computer system is received in action block 123 either by manual input or from a suitable database 121. In this embodiment, database 121 has been loaded with a matrix or other data structure of products related to computer systems. Accordingly, suitable programming determines products which are related to the particular purchased computer system in action block 124. This determination is made as a function of the information received about the customer's purchased computer system, and by accessing the records or data contained in database 121, and then applying certain association or categorization comparisons to determine the products related to the computer system.

Suitable programming or inputs are provided to determine dollar amounts corresponding to the related products, or the dollar amounts can be simply entered manually, as shown in action block 129. The determination of the dollar amounts preferably involves a percentage of the cost(s) or prices(s) of the related product(s) as detailed with respect to the previous embodiment of FIG. 2.

In this embodiment, the information about the purchased computer system is also one of the variables used to calculate the cost per predetermined unit of time for the warranty extension, as shown by action block 125.

Returning to the step where related products have been determined (action block 124), the related products are optionally compared to the information about the customer's purchased computer system to generate an additional set of related products which are of potential interest to the customer. These computer-assisted actions are shown schematically at action blocks 126 and 128. It should be understood that the term “set” does not indicate any particular data structure or grouping and can be either a physical grouping, logical grouping, or other suitable data structure useful by the associated steps or programming routines of the invention.

These comparisons and the generation of a set of products of potential interest to a customer are accomplished by suitable programming which optionally includes routines for “weighting,” by means of so-called artificial intelligence, those related products more likely to be of interest to the customer. The weighting is preferably based on the customer's previous purchases, current computer system configuration, past purchasing habits, line of business of the customer, computer networking parameters, and all the other factors useful in creating an artificial-intelligence or knowledge-based programming subroutine. One or more of such factors are thus used to generate a set of related products of potential interest to the customer. An alternate and similar methodology for generating a set of products of potential interest to the customer is simply to remove from the product set those computer products already owned by the customer and which do not need replacement, upgrading, or additional quantities thereof.

Whatever level of sophistication or programming is used, a set of related products is generated which includes some or all of the universe of products related to the customer's computer system. This set of related products has corresponding dollar amounts for each of the related products previously determined in step 129. The dollar amounts are added up, as shown in action block 130. As the dollar amounts of the related products of potential interest to the customer are totaled, the sum or total is compared to the cost per predetermined unit of time for the warranty extension (logic block 132). If the sum or total of the dollar amounts is greater than or equal to the cost for the unit of time for the warranty extension, then, in the embodiment shown in FIG. 3, those related products which have been added up to reach such total are the basis for an offer of warranty extension to a customer. The related products are grouped into a corresponding set, as shown in action block 134.

If this offer of the corresponding set of related products is accepted, that is, the set of related products is purchased, then the warranty of the customer's computer system is extended by an amount corresponding to the total amount of the related products purchased. In this embodiment, the warranty extension is greater than or equal to the predetermined unit of time for the warranty extension calculated in step 125. Thus, in the embodiment illustrated schematically in FIG. 3, the period of time for the warranty extension is predetermined, for example, at one month. Then, the associated costs for such warranty extension are determined and a corresponding amount of related products must be purchased before the warranty extension can be applied. In contrast, in the previous embodiment shown schematically in FIG. 2, there was no predetermined minimum amount of warranty extension, and incremental purchases of related products resulted in incremental extensions of warranty, no matter how large or small.

Returning now to the embodiment shown schematically in FIG. 3, there is a great amount of flexibility in determining which set of related products from the universe of available related products are grouped together and offered to the customer to extend the warranty. In other words, once a determination has been made of which products are of potential interest to the customer, different combinations of such related products of interest can be put together as a set and offered to the customer, so long as the dollar amounts associated with such a set exceed the cost of the warranty extension (logic block 132).

In one mode of operation, then, a seller can generate multiple sets of related products, all of which are of potential interest to the customer, all of which have the potential for extending the warranty by at least the predetermined period of time, but which differ as to the exact contents of the set. In this way, the seller can present alternative sets of related products to the customer, giving the customer the choice of which related products to purchase to extend the warranty on the originally purchased computer system. These alternative sets can either be presented simultaneously or over a period of time to the customers. As still a further alternative, the customer can be presented the complete list of related products generated by the method being described, along with associated dollar amounts, and can create the set of products to trigger the warranty extension.

If the customer does not purchase a particular set, suitable programming can be provided to generate an alternate set as shown by action box 136. Such programming can include factors or variables which “weigh” the characteristics of the first set of related products which was rejected, and generate the second set to differ from such first set in hopes of getting the customer to purchase it.

The process and associated computer implementation illustrated in FIG. 3 can be adapted for a computer system which has multiple computer products with corresponding computer warranties associated with such products. In such implementation, the calculation of the cost per predetermined time period for the warranty extension in action block 125 involves determining or receiving as input a warranty subcost associated with each of the computer products of the computer system and then totaling the warranty subcosts for the individual computer products so as to determine an overall cost for the warranty extension for the computer system. The foregoing approach is particularly well-suited for customers that have multiple personal computers included within their computer system. In such situation, the process or method of generating warranty extension offers proceeds similarly to that discussed in general for the customers' computer system.

Certain optional steps or alternate routines are also available. For example, the process can be implemented to generate a set of related products for individual computers of the computer system and thus a corresponding warranty extension for the individual computers of the system. Alternately, a suitable rule or computation can be devised where the subcost of the warranties for the individual computers or computer products are used to determine a cost for merging such separate warranties into a single warranty for the customers computer system or corresponding single warranty extension for such customer's computer system. As such, the method can merge into a single warranty or warranty extension the complex situation of multiply computer products purchased at different points in time and thus having different warranty expiration dates. Again, as discussed previously, once the cost for such single warranty has been determined, one or more sets of related products can be generated by action blocks 128, 130, 132, and 134 to either merge or extend the merged warranty upon purchase of the appropriate set of related goods.

Still further variations of the illustrated process and associated computer implementation can be devised to address a variety of customer marketing opportunities. For example, the situation my arise where a customer's computer system comprises a mix of at least one computer from a competitive supplier, and the seller wishes to make inroads into this customer account which purchased competitive goods previously. In this scenario, actions are taken, preferably by suitable computer programming, to compute the cost per predetermined unit of time for providing warranty coverage to the competitive computer product. This cost, in turn, is factored into the costs per predetermined unit of time for the customers' computer system after purchase of the computer with warranty from the potential seller, as well as any related goods from the same seller, to determine a cost for a system-wide warranty extension. Such system-wide extension includes the computer or computers of the competitive seller and the related goods of the potential seller, including, in this case, at least one related good with a warranty associated with it. Once this cost determination has been made, the seller can generate an appropriate offer of the related goods. Upon acceptance of such offer, the customer gets his system-wide warranty which extends not only to the purchase of the related goods, but also to the original computer purchased from the competitor. The above process is likewise applicable in cases where the warranty on the competitor's computer previously purchased has expired.

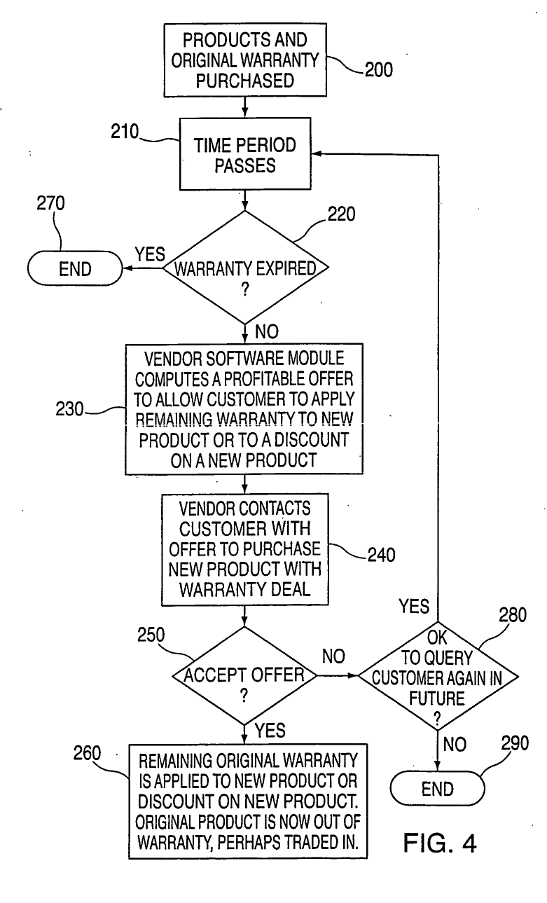

Another preferred embodiment of the invention is shown schematically with reference to FIG. 4. As in the previous embodiments, a product or good, such as a computer system, has been purchased by the customer along with an original warranty in step 200. Either upon such purchase or, optionally, after a period of time has passed (step 210), the seller institutes the method of the present invention, this time seeking to induce the sale of goods related to the originally purchased product by applying the unused warranty from the originally purchased good either (1) to reduce the price of the related goods offered, or (2) to establish a warranty for such related goods.

In step 220, a determination is made whether the warranty on the originally purchased product has expired. If yes, then there is no unused warranty remaining to apply or “credit” as detailed subsequently. If the warranty has not expired, then a suitable computer routine, in general terms, computes a profitable offer to allow the customer to apply its remaining warranty to a new, related product. Once a suitable offer has been generated, as in the previous embodiments, the seller presents the offer to the customer (step 240), which customer either does or does not except the offer (step 250), and a suitable database or records are updated in step 260 to reflect the application of the unused warranty to the purchase of the related goods. If the offer is rejected, the customer is optionally queried as to whether future offers should be made (step 280), and another offer is generated either immediately or at some point in time in the future. Customer accounts can be flagged for periodic follow up under the system, just as disclosed previously with respect to the other embodiments.

The computation of an offer to apply unused warranty to the new product, in action block 230, is now described in more detail. Preferably, the method involves receiving an input corresponding to the amount of the unused warranty on the purchase good. Information about the product which has the unused warranty is also available either by access to a suitable database or through any suitable input. This information preferably includes the age of the product, its manufacturer, the cost of in-warranties support for similar products, or other factors and variables appropriate and useful to assessing the cost or value of such unused warranty.

To that end, the above-described information is used in conjunction with the time period of the unused warranty to calculate a value of the unused warranty on the purchased good.

The method makes use of information for at least one good related to the purchased good, such information being similar to that described with reference to the previous embodiments. In this embodiment, however, the related good preferably has a warranty associated with it and the information for the related good preferably includes the costs of such warranty. Accordingly, in the context of computer systems, one applicable scenario would be that the purchased good comprises a first computer, and the related good comprises a newer computer to replace or upgrade the originally purchased computer or expand the customers' computer system. The new computer would have a warranty associated with it, and information related to the cost of such warranty would be part of the computations of the method illustrated in FIG. 4.

In particular, the value of the unused warranty previously determined for the purchased good and the information for the related good would be variables or factors used to perform at least one of the following steps: the purchase price of the related good could be reduced by an amount corresponding to the value of the unused warranty; and/or a warranty for the related good could either be established in the case where the related good has no original warranty, or the warranty on the related good could be extended in a case of a related good with a warranty, such as new computer.

Some or all of the actions, computations, and information management are preferably part of a computer implementation or database, as appropriate. For example, the various programming routines can be stored as software applications on a server computer, a host computer, a personal computer. Alternately, the programming can be made available through an application service provider (ASP), it can be downloaded to a handheld or personal digital device, or it can be made resident on any other suitable computational system. In one preferred embodiment, employees or agents of the seller can access the application and any associated databases over a local area network, a wireless network, through a terminal connected to the internet, or by any of the variety of ways to network to appropriate software applications and databases. In such implementation, the employee or agent of the seller can operate the associated computing routines to generate appropriate warranty extension offers and sets of related goods for extending the warranties. Depending on the nature of the networking of the agent or seller, the customer can be presented with offers during customer visits or at any other suitable opportunity.

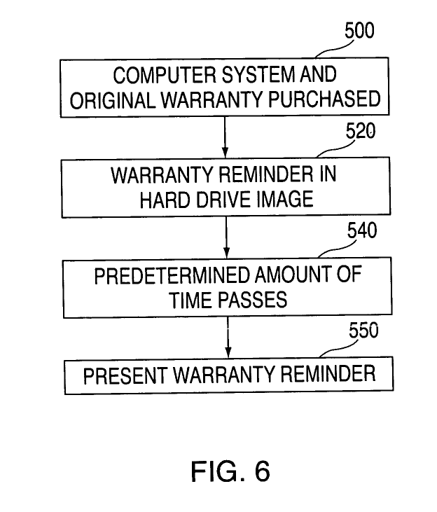

Referring to FIG. 6, still another aspect of the present invention is to provide reminders regarding extended warranty offers to customers who have purchased goods, as shown in action block 550. In one embodiment the warranty reminder is located on the hard drive of the customer's computer, as shown in action block 520. Optionally, the warranty information about the components of the system is downloaded at manufacturing download time. After a predetermined time passes (action block 540), such a warranty reminder is presented automatically to a customer, that is, without requiring the customer to take active steps related to an extended warranty or reminders therefor as shown in action block 550. For example, a customer would not have to actively seek out information that would trigger a warranty offer or actively seek out a warranty offer itself. A customer would likewise not have to rely on accessing a web site in order to trigger receiving a warranty reminder or a warranty offer. Additionally, a customer would not need to be subject to electronic interrogation regarding the customer's existing computer system in order to receive a warranty reminder or warranty offer. Moreover, there would be no need for a customer to send e-mail correspondence to inquire or seek out information regarding warranty offers.

The warranty reminder may be presented in such a way so that it encourages the user or customer to purchase an extended warranty offer, for example, after a predetermined time after a customer purchases a computer system or when the existing warranty is soon to expire. Such reminders may consist of, but are not limited to, pop-up reminders, tool bar reminders, presentations of web pages, e-mail messages or other multimedia presentations.

As shown in action block 540, a predetermined amount of time passes. After the predetermined amount of time passes, the warranty reminder is presented, as shown in action block 550. For example, the warranty reminder may be initiated a predetermined set of days after the customer initially activates the computer or computer system, a predetermined set of days after a customer initially purchases a computer or computer system, after a specified number of reboots of the computer, on a predetermined date or any combination thereof.

In accordance with one embodiment of the invention, the warranty reminder relates to warranty information associated with the computer or computer system. The warranty information may include information about the customer's computing system such as the type and brand of each component part, the price of each such component part, existing warranty information, and any other information relevant in generating a warranty offer or warranty reminder.

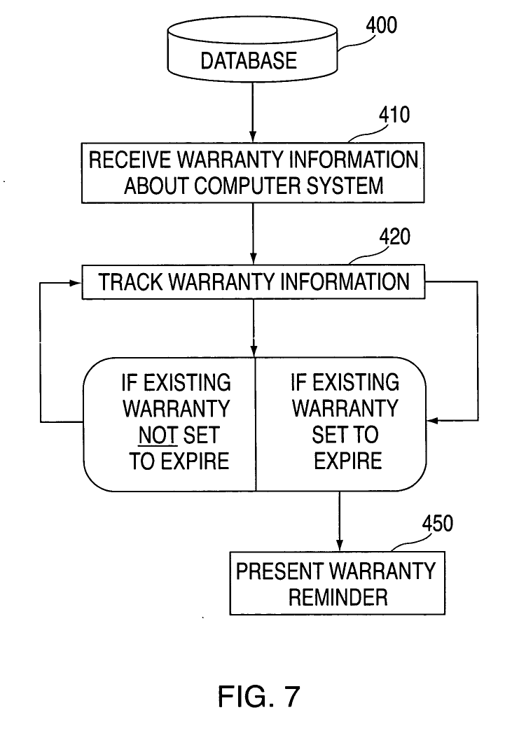

Referring to FIG. 7, warranty information is contained in a database accessible to the customer or the customer's computer system (action block 400). Such warranty information may be collected from a variety of sources, including, but not limited to, sales systems, vendor databases or any other information that may be relevant in determining and creating a warranty offer, and compiled in a warranty information database. For example, product identification information corresponding to products purchased at a point of sale may be input into the warranty information database, and such information and other warranty information may be received by the customer's computer system (action block 410).

Moreover, an application or software program is capable of accessing the warranty information database, which could optionally include extended warranty information, sale information relating the customers computer system and individual warranty information, and so forth.

In a further aspect of one embodiment of the present invention, the warranty information may be tracked by the software program, as shown in action block 420. The software program may access the warranty information database and may inform a user or a customer of the computer system when existing warranties relating to the computer system are expiring and may also remind the user of extended warranty offers. This may be accomplished by the software application tracking the date the existing warranty expires and comparing it to the warranty information. Accordingly, at a predetermined time, e.g., when the existing warranty is set to expire, a warranty reminder may be presented, as shown in action block 450.

However, the present invention is not limited to the software application reminding users of extended warranty offers by tracking the date the existing warranty expires as the only means of providing warranty reminders. The warranty information may be stored on the computer system's hard drive in a database or may be stored on an external database. The warranty information may be stored on a server or other device external to the computer system or may be located in a server in the customer's network. Optionally, the warranty information may be stored at the web server of the seller, across web servers of multiple vendors, or at other networked locations. Additionally, such a database may be downloaded into flash memory.

The software application may run as a background application under the Operating System, requiring minimum computer resources. The software application may then alert a user of the computer system of a warranty extension reminder at an appropriate time.

Warranty information may be created in a variety of ways. In one embodiment, point-of-sale (POS) product information or other information related to the computer system is added to warranty information, which may eventually be used in connection with warranty offers. In another embodiment, information is downloaded into the hard drive image. In yet another embodiment of the invention, the warranty information is downloaded via a dynamic hard drive. Dynamic storage devices would also include Random Access Memory (RAM).

Updates, messages and reminders may be provided through web-based application downloads of warranty information that may include options such as warranty offers. Optionally, messages may be presented to a customer through an e-mail message or through a web page. Moreover, reminders may be saved on the hard drive for future presentation.

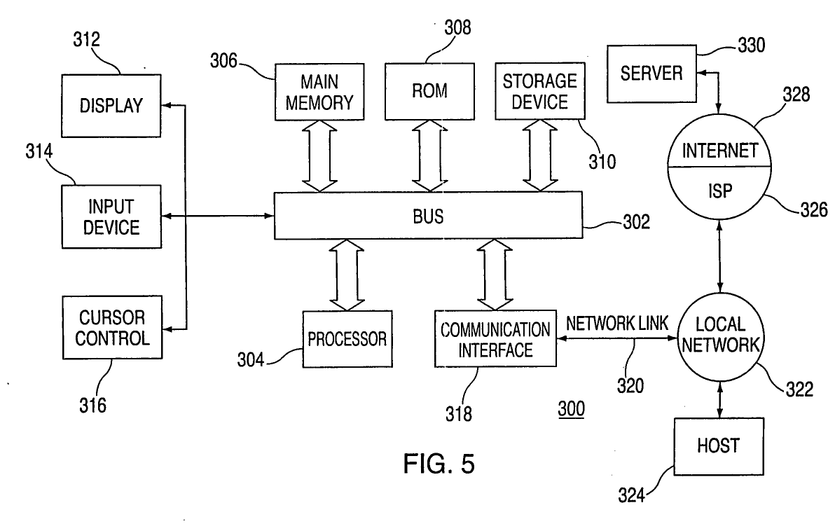

Referring back to FIG. 5, one suitable computer system upon which an embodiment of the invention may be implemented is shown at 300. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

According to one embodiment of the invention, computer system 300 operates in response to processor 304 executing one or more sequences of one or more instructions contained in main memory 306. Such instructions may be read into main memory 106 from another computer-readable medium, such as storage device 310. Execution of the sequences of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware circuitry and software.

A software application embodying the invention can be stored or reside in any suitable computer-readable medium. The term “computer-readable medium” as used herein refers to any medium that participates in providing instructions to processor 304 for execution. Such a medium may take many forms, including, but not limited to, non-volatile media, volatile media, and transmission media. Non-volatile media include, for example, optical or magnetic disks, such as storage device 310. Volatile media include dynamic memory, such as main memory 306. Transmission media include coaxial cables, copper wire, and fiber optics, including the wires that comprise bus 302. Transmission media can also take the form of acoustic or light waves, such as those generated during radio frequency (RF) and infrared (IR) data communications. Common forms of computer-readable media include, for example, floppy disk, a flexible disk, hard disk, magnetic tape, and other magnetic medium, a CD-ROM, DVD, any other optical medium, punch cards, paper tape, any other physical medium with patterns of holes, a RAM, a PROM, an EPROM, a FLASHEPROM, any other memory chip or cartridge, a carrier wave as described hereinafter, or any other medium from which a computer can read.

Various forms of computer-readable media may be involved in carrying one or more sequences of one or more instructions to processor 304 for execution. For example, the instructions may initially be borne on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306, from which processor 304 retrieves and executes the instructions. The instructions received by main memory 106 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic, or optical signals that carry digital data streams representing various type of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network, now commonly referred to as the “Internet” 328. Local network 322 and Internet 328 both use electrical, electromagnetic, or optical signals that carry digital data streams. The signals through the various networks and the signals on network line 320 and through communication interface 318, which carry the digital data to and from computer system 300, are exemplary forms of carrier waves transporting the information.

Computer system 300 can send messages and receive data, including program codes, through the network(s), network line 320, and communication interface 318. In the Internet example, a server 330 might transmit a requested code for an application program through Internet 328, ISP 326, local network 322, and communication interface 318.

In accordance with the invention, one such application program provides for determining warranty extensions as described herein.

The received code may be executed by processor 304 as it is received, and/or stored in storage device 310, or other non-volatile storage for later execution. In this manner, computer system 300 may obtain an application code in the form of a carrier wave.

It is understood that the above described computer system has been presented for the purposes of illustration and description only, and any number of alternative computer-based implementations can be devised and are suitable for practicing and implementing the invention.

In addition to the advantages apparent from the foregoing description, the method and associated system for generating warranty extension offers gives a seller of products related to the original products an additional inducement to the prospective purchaser of such related products, by extending a warranty as a result of such purchase.

When the original product was purchased from the seller, and the seller desires to sell related products, the method encourages “brand loyalty” by “rewarding” the customer with a warranty extension upon purchase of related goods from the same seller as the original products.

As a still further advantage, the complexity of multiple warranties on a multi-component computer system can be simplified in the course of offering additional, related goods for the customer to add to its computer system.

Still further, existing warranties are given a “cash value” and can be used to encourage the purchase of related goods by applying the value of the unused warranty to such related goods, or by extending such unused warranty to establish or extend the warranty on the related goods.

Alternative embodiments to those discussed herein may be devised by those having skill in the art, such alternatives, as well as others which skill or fancy may suggest, are considered to fall within the scope of the current invention, which is solely defined by the claims as pended hereto.

What is claimed is:

1. A method for presenting a warranty reminder relating to a warranty extension offer for a customer's computer system, the method comprising the steps of:
storing warranty information in the hard drive image on a customer's computer system;
preparing a warranty extension offer corresponding to the warranty information; and
presenting the warranty extension offer to a customer after a predetermined amount of time through a warranty reminder, wherein the warranty reminder is automatically presented to the customer.

2. The method of claim 1, wherein the step of presenting the warranty extension offer to a customer after a predetermined amount of time through a warranty reminder further comprises the steps of:
installing a software program on the customer's computer system corresponding to the warranty reminder; and
presenting the warranty reminder through application of the software program.

3. The method of claim 1, wherein the step of presenting the warranty extension offer to the customer after a predetermined amount of time through a warranty reminder further comprises the steps of:
transmitting a download request to a download server;
receiving a download reply containing files to a software program corresponding to the warranty reminder;
processing the downloaded reply containing files to the software program in order to install the software program corresponding to the warranty reminder; and
presenting the warranty reminder through application of the software program.

4. The method of claim 1, wherein the predetermined amount of time comprises a predetermined number of reboots of the computer system or a predetermined number of days after a customer initially activates the computer system.

5. A method for presenting a warranty reminder relating to a warranty extension offer for a customer's computer system, the method comprising the steps of:
receiving input corresponding to warranty information about a customer's computer system;
preparing a warranty extension offer corresponding to the warranty information; and
presenting the warranty extension offer through a warranty reminder, wherein the warranty reminder is automatically presented to a customer.

6. The method of claim 5, wherein the step of receiving input corresponding to warranty information about the customer's computer system further comprises the step of accessing a database for receiving the input.

7. The method of claim 5, wherein the step of receiving input corresponding to warranty information about the customer's computer system further comprises the step of downloading the warranty information at manufacturing download time.

8. The method of claim 5, further comprising the steps of:
installing a software program corresponding to the warranty reminder; and
presenting the warranty reminder through application of the software program.

9. The method of claim 8, wherein the step of installing the software program further includes the step of downloading the software program corresponding to the warranty reminder.

10. The method of claim 5, further comprising the step of storing the warranty information through a dynamic storage device.

11. The method of claim 5, further comprising communicating the warranty reminder through presentation of a web page or through electronic mail.

12. The method of claim 8, further comprising communicating the warranty reminder through presentation of a web page or through electronic mail.

13. A method for presenting a warranty reminder relating to a warranty extension offer for a customer's computer system, the method comprising the steps of:
installing a software program corresponding to the warranty reminder;
storing warranty information in the hard drive image on a customer's computer system;
preparing a warranty extension offer corresponding to the warranty information;
presenting the warranty extension offer to a customer automatically after a predetermined amount of time through a warranty reminder; and
presenting the warranty reminder through application of the software program.

14. A method for generating and presenting a warranty reminder relating to a warranty extension offer for a customer's computer system, the method comprising the steps of:
receiving input corresponding to information about the customer's computer system;
computing the cost per predetermined unit of time for the warranty extension as a function of the information;
determining products related to the customer's computer system as a function of the information;
for each said related product, determining a dollar amount corresponding to a predetermined percentage of the cost or price of said related product;
adding up the dollar amounts of at least a portion of the related products until a corresponding total of the dollar amounts is greater than or equal to the cost for the warranty extension offer for the predetermined unit of time;
incorporating the information into the warranty information;
preparing a warranty extension offer corresponding to the warranty information; and
presenting the warranty extension offer to a customer automatically through a warranty reminder after a predetermined amount of time.

15. The method of claim 14, wherein the information about the customer's computer system includes the particular computer products comprising the computer system and the age of the computer products.

16. The method of claim 14, wherein the step of incorporating the information into the warranty information further comprises the step of accessing a database storing the warranty information.

17. The method of claim 14, wherein the step of receiving input corresponding to information about the customer's computer system further comprises the steps of accessing a database including customer records and retrieving the information.

18. The method of claim 14, wherein warranty information comprises information about an individual's personal computer, products related to the customer's computer system, customer sales data and vendor information.
